(19) United States
(12) Patent Application Publication
(10) Pub. No.: US 2021/0224711 A1
(43) Pub. Date: Jul. 22, 2021

(54) SERVER APPARATUS, CONTROL APPARATUS, MEDIUM, MOBILE SHOP, AND OPERATION METHOD FOR INFORMATION PROCESSING SYSTEM

(71) Applicant: TOYOTA JIDOSHA KABUSHIKI KAISHA, Toyota-shi (JP)

(72) Inventors: Ryosuke KOBAYASHI, Nagakute-shi (JP); Ayana TAKESHITA, Kasugai-shi (JP); Naoki YAMAMURO, Nagoya-shi (JP); Takuya MAEKAWA, Nagoya-shi (JP); Yugo SAKURAI, Setagaya-ku (JP)

(73) Assignee: TOYOTA JIDOSHA KABUSHIKI KAISHA, Toyota-shi (JP)

(21) Appl. No.: 17/140,209

(22) Filed: Jan. 4, 2021

(30) Foreign Application Priority Data
Jan. 21, 2020 (JP) 2020-007875

(51) Int. Cl. G06Q 10/06; G06Q 10/08; G06Q 20/20; G06Q 50/12; A23L 5/10

(52) U.S. Cl. CPC G06Q 10/06315; G06Q 10/087; H04L 67/12; G06Q 50/12; A23L 5/10; G06Q 20/203

(57) ABSTRACT

A server apparatus includes a communication interface and a controller that transmits and receives information to and from other apparatuses via the communication interface. The controller receives, from a shop terminal apparatus of a shop, information on a food product to be collected and transmits, to a mobile shop that collects the food product, a reconfiguration procedure for reconfiguring an ingredient included in the food product to yield a reconfigured food product having an expiration date later than an expiration date of the food product. The controller prompts the mobile shop to sell the reconfigured food product.

### CROSS-REFERENCE TO RELATED APPLICATION

This application claims priority to Japanese Patent Application No. 2020-7875 filed Jan. 21, 2020, the entire contents of which are incorporated herein by reference.

### TECHNICAL FIELD

The present disclosure relates to a server apparatus, a control apparatus, a medium, a mobile shop, and an operation method for an information processing system.

### BACKGROUND

Methods for stimulating the sale of food products near their expiration date have been proposed to avoid the loss of resources that results from discarding products past their expiration date in food shops, and to avoid loss related to excess inventory. For example, patent literature (PTL) 1 discloses a system that associates willing sellers and willing buyers of food products near their expiration date and that supports delivery of the food products.

### CITATION LIST

### Patent Literature

PTL 1: JP 2002-236811 A

### SUMMARY

Techniques for stimulating the sale of products near their expiration date have room for improvement in further increasing the sales efficiency.

It would be helpful to provide a server apparatus capable of increasing the sales efficiency of products near their expiration date.

A server apparatus according to the present disclosure includes a communication interface and a controller configured to transmit and receive information to and from other apparatuses via the communication interface. The controller is configured to receive, from a shop terminal apparatus of a shop, information on a food product to be collected; transmit, to a mobile shop configured to collect the food product, a reconfiguration procedure for reconfiguring an ingredient included in the food product to yield a reconfigured food product having an expiration date later than the expiration date of the food product; and prompt the mobile shop to sell the reconfigured food product.

A control apparatus of a mobile shop according to the present disclosure is to be mounted in the mobile shop and is configured to transmit and receive information to and from a server apparatus and to control the mobile shop. The control apparatus is configured to receive a reconfiguration procedure from a server apparatus configured to receive, from a shop terminal apparatus of a shop, information on a food product to be collected. The reconfiguration procedure is a procedure for a mobile shop configured to collect the food product, to reconfigure an ingredient included in the food product and yield a reconfigured food product having an expiration date later than the expiration date of the food product. The control apparatus is configured to output an instruction to collect the food product from the shop, reconfigure the food product, and sell the reconfigured food product.

An operation method for an information processing system according to the present disclosure is an operation method for an information processing system including a server apparatus and a mobile shop configured to communicate with the server apparatus. The operation method includes receiving, at the server apparatus from a shop terminal apparatus of a shop, information on a food product to be collected, transmitting, from the server apparatus to the mobile shop, a reconfiguration procedure for reconfiguring an ingredient included in the food product to yield a reconfigured food product having an expiration date later than the expiration date of the food product, and prompting, by the server apparatus, the mobile shop to sell the reconfigured food product.

The server apparatus and the like according to the present disclosure can increase the sales efficiency of food products near their expiration date.

### BRIEF DESCRIPTION OF THE DRAWINGS

In the accompanying drawings:

FIG. 1 illustrates an example configuration of an information processing system;

FIG. 2 illustrates an example configuration of a server apparatus;

FIG. 3 illustrates an example configuration of a terminal apparatus;

FIG. 4 illustrates an example configuration of a mobile shop;

FIG. 5A illustrates an example of food product information and the like;

FIG. 5B illustrates an example of food product information; and

FIG. 6 is a sequence diagram illustrating an operation example of the information processing system.

### DETAILED DESCRIPTION

Embodiments are described below.

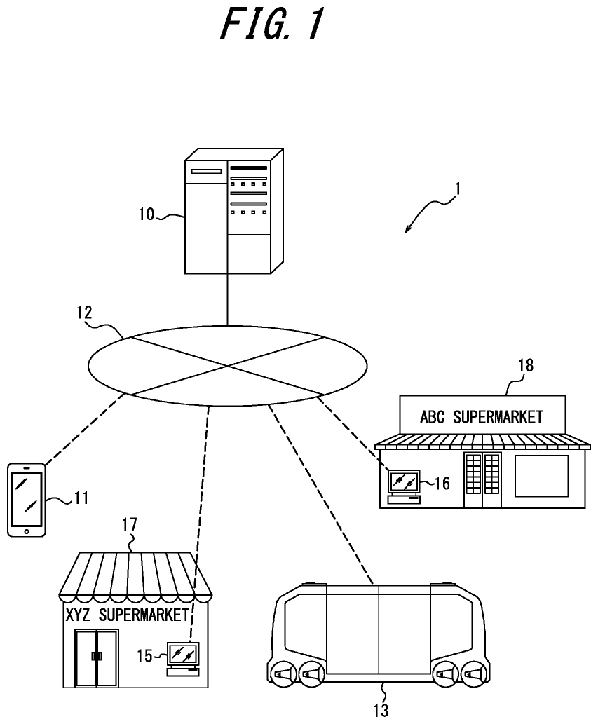

FIG. 1 illustrates an example configuration of an information processing system in an embodiment. The information processing system 1 includes, for example, a server apparatus 10, terminal apparatuses 11, 15, 16, and a mobile shop 13, that are communicatively connected to each other via a network 12. The server apparatus 10 is a computer. The terminal apparatus 11, 15, 16 are, for example, information terminal apparatuses such as personal computers, tablet terminal apparatuses, or smartphones. The terminal apparatuses 15, 16 are respectively installed in food retail shops 17, 18. The retail shops 17, 18 are, for example, supermarkets, convenience stores, or the like. The terminal apparatus 11 is used by a consumer purchasing a food product. The terminal apparatuses 11, 15, 16 are referred to below as a consumer terminal apparatus 11 and shop terminal apparatuses 15, 16. The mobile shop 13 is a multi-purpose vehicle equipped with shop facilities and with control and communication functions. The network 12 is, for example, the Internet, but may include an ad hoc network, a LAN, a metropolitan area network (MAN), or other networks, or any combination thereof. The number of each component included in the information processing system 1 may be greater than the case illustrated here.

The information processing system 1 supports increased sales efficiency of food products near their expiration date in the retail shops 17, 18. The “expiration date” as used in the present embodiment encompasses the “consume by date” indicating the limit for safe consumption of each food product and the “best by date” through which quality is maintained. The expiration date may also be a freely set date after which sale of the food product is problematic, requiring disposal of the food product. The server apparatus 10 receives information related to the expiration date of food products to be collected from the shop terminal apparatuses 15, 16 of the retail shops 17, 18. The food products to be collected are food products that are sold by the retail shops 17, 18 and have an expiration date that is near, i.e. within a freely set period of time. The server apparatus 10 transmits a reconfiguration procedure for reconfiguring a collected food product and information related to an extended expiration date of the reconfigured food product to the mobile shop 13 that collects food products. The server apparatus 10 prompts the mobile shop 13 to sell the reconfigured food product. The expiration date of the collected food product depends on the expiration date of the ingredients included in the food product. Accordingly, the expiration date of the reconfigured food product can be extended if the food product is reconfigured by the ingredients thereof being cooked, removed, or replaced. The mobile shop 13 includes a kitchen facility, reconfigures the collected food product in accordance with the reconfiguration procedure, and sells the reconfigured food product with the extended expiration date to the consumer. In this way, the information processing system 1 can increase the sales efficiency of food products near their expiration date in the retail shops 17, 18. The sales opportunities of food products that might have been discarded for being past their expiration date can thus be expanded, and the amount of excess inventory discarded in a retail shop can be reduced.

In the present embodiment, a food product refers to an individual item sold by the retail shops 17, 18. The food product may, for example, include one or more uncooked or cooked ingredients. Uncooked ingredients may include processed ingredients or raw ingredients that were harvested or caught. Processed ingredients are the result of treating/processing raw ingredients, which were harvested or caught, to become suitable for cooking. Food products may, for example, be individual fruits, packaged cut-up fruit, packaged dressed/processed meat, an individual piece of seafood, packaged processed seafood, or packaged salad, side dishes, boxed meals, or the like that combine a plurality of types of cooked or uncooked ingredients.

When the expiration date of a food product is set to match the ingredient having the earliest expiration date (nearly expired ingredient) among one or more cooked or uncooked ingredients included in the food product, the food product can be reconfigured in the following way to extend the expiration date of the reconfigured food product overall. For example, when the nearly expired ingredient is uncooked, one or more ingredients including the nearly expired ingredient can be cooked to extend the expiration date of the cooked ingredient, thereby extending the expiration date of the resulting reconfigured food product overall. The nearly expired ingredient can also be removed to yield a reconfigured food product that, overall, has an extended expiration date. Furthermore, the nearly expired ingredient can be replaced by a different uncooked or cooked ingredient with a greater margin before the expiration date to yield a reconfigured food product that, overall, has an extended expiration date. In this case, the replacement ingredient used to replace the nearly expired ingredient is acquired from another food product, or from another reconfigured food product that was reconfigured by cooking. The reconfiguration procedure is therefore a procedure to cook one or more ingredients, including the uncooked nearly expired ingredient, found in the food product or a procedure to remove one or more cooked or uncooked nearly expired ingredients or replace them with ingredients included in another food product or reconfigured food product. The present embodiment can also expand the options for ingredients used in the reconfiguration procedure by combining ingredients of food products collected from different retail shops 17, 18.

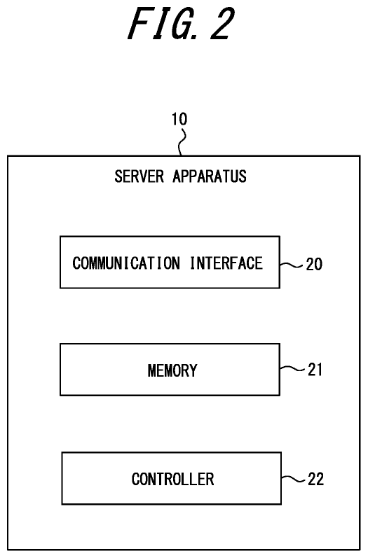

FIG. 2 illustrates an example configuration of the server apparatus 10. The server apparatus 10 includes a communication interface 20, a memory 21, and a controller 22. The server apparatus 10 may execute operations in the present embodiment by communicating and cooperating with another server apparatus having the same configuration.

The communication interface 20 includes a communication module compliant with one or more wired or wireless LAN standards for connecting to the network 12. In the present embodiment, the server apparatus 10 is connected to the network 12 via the communication interface 20 and communicates information with other apparatuses over the network 12.

The memory 21 includes, for example, a semiconductor memory, a magnetic memory, or an optical memory. The memory 21 functions as, for example, a main storage device, an auxiliary storage device, or a cache memory. The memory 21 stores any information, control and processing programs, and the like used in the operation of the server apparatus 10.

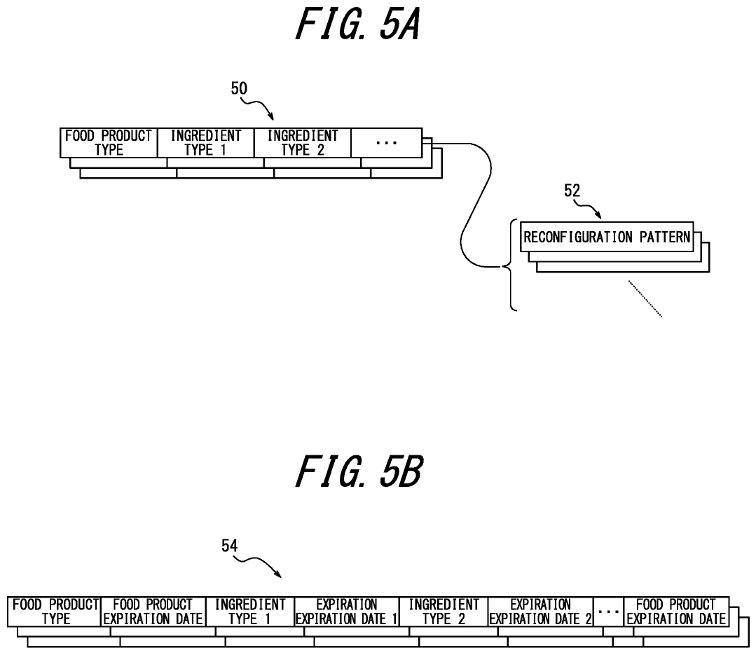

The memory 21 stores food product information 50 on the food products collected from the retail shops 17, 18 as illustrated in FIG. 5A, for example. For each food product, the food product information 50 includes information items such as a food product type indicating the type of the food product and an ingredient type 1, ingredient type 2, . . . indicating the types of ingredients included in the food product. The food product information 50 includes one or more ingredient types for each food product type. The ingredient type includes information indicating whether the ingredient is cooked or uncooked.

The memory 21 stores reconfiguration procedure information 52 on the reconfiguration procedure for reconfiguring the food product. The reconfiguration procedure information 52 includes reconfiguration patterns, serving as a template for the reconfiguration procedure, as information items. The reconfiguration procedure information 52 includes a plurality of reconfiguration patterns for each piece of food product information 50. The reconfiguration pattern includes a pattern of a procedure to cook one or more ingredients, including the uncooked nearly expired ingredient, found in the food product or a pattern of a procedure to remove one or more cooked or uncooked nearly expired ingredients or replace them with ingredients included in another food product or reconfigured food product. The reconfiguration pattern may, for example, be a pattern of a procedure to cook or otherwise prepare uncooked fruit, meat, seafood, or the like to reconfigure a side dish such as stir-fried vegetables, grilled meat, or grilled fish, or a pattern of a procedure to remove, or replace with other ingredients, one or more cooked or uncooked ingredients included in a packaged salad, side dish, boxed meal, or the like to reconfigure the packaged salad, side dish, boxed meal, or the like as a new food product.

Returning to FIG. 2, the controller 22 may include one or more general purpose processors, such as a central processing unit (CPU), or one or more dedicated processors specialized for a particular process. Alternatively, the controller 22 may include dedicated circuitry such as one or more field-programmable gate arrays (FPGAs) or application specific integrated circuits (ASICs). The controller 22 operates according to a control and processing program, or operates according to an operation procedure implemented as a circuit, to comprehensively control the operation of the server apparatus 10. The controller 22 transmits and receives various information to and from the consumer terminal apparatus 11, the shop terminal apparatuses 15, 16, and the mobile shop 13 via the communication interface 20 and executes the operations according to the present embodiment.

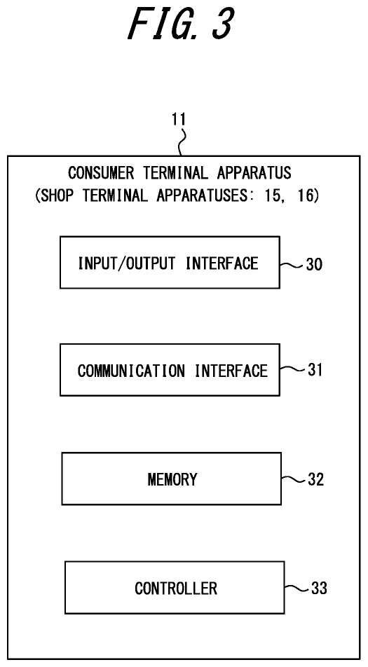

FIG. 3 illustrates an example configuration of the consumer terminal apparatus 11. The example configuration of the consumer terminal apparatus 11 illustrated here also applies to the shop terminal apparatuses 15, 16. The consumer terminal apparatus 11 is an information processing terminal apparatus, such as a personal computer, a tablet terminal apparatus, or a smartphone. The consumer terminal apparatus 11 includes an input/output interface 30, a communication interface 31, a memory 32, and a controller 33.

The input/output interface 30 includes an input interface that detects user input and transmits the input information to the controller 33. The input interface may be any type of input interface, such as a physical key, a capacitance key, a touch screen integrally provided with a panel display, various pointing devices, a microphone for receiving audio input, or a camera for capturing images or image codes. The input/output interface 30 also has an output interface for outputting information generated by the controller 33 or received from another apparatus to the user. Such an output interface may be any type of output interface, such as an external or built-in display for outputting information as an image or video, a speaker for outputting information as audio, or an interface for connection with an external output device.

The communication interface 31 includes a communication module compliant with a wired or wireless LAN standard, a module compliant with a mobile object communication standard such as the 4th generation (4G) standard or the 5th Generation (5G) standard, or the like. The consumer terminal apparatus 11 is connected by the communication interface 31 to the network 12 via a nearby router or a base station for mobile object communication and communicates information with other apparatuses over the network 12.

The memory 32 includes, for example, a semiconductor memory, a magnetic memory, or an optical memory. The memory 32 functions as, for example, a main storage device, an auxiliary storage device, or a cache memory. The memory 32 stores any information, control and processing programs, and the like used in the operation of the consumer terminal apparatus 11.

In the case of the shop terminal apparatuses 15, 16, the memory 32 stores food product information 54 on the food products sold by the retail shops 17, 18, as illustrated in FIG. 5B, for example. For each food product, the food product information 54 includes information items such as a food product type indicating the type of the food product, a food product expiration date indicating the expiration date of the food product, an ingredient type 1, ingredient type 2, . . . indicating the types of ingredients included in the food product, and an ingredient expiration date 1, ingredient expiration date 2, . . . indicating the expiration date of each ingredient. The food product expiration date has the same value as the earliest expiration date among the ingredient expiration dates. The ingredient type includes information indicating whether the ingredient is cooked or uncooked. The ingredient expiration date is freely set based on the time the ingredient was harvested/caught, manufactured, cooked, or the like. The food product expiration date and the ingredient expiration date are stored in the memory 32 by a clerk of the retail shops 17, 18 setting/inputting the dates on the shop terminal apparatuses 15, 16 when products arrive or by the clerk inputting information, set in advance by the wholesaler of the ingredients, on the shop terminal apparatuses 15, 16 when products arrive.

The controller 33 may, for example, include one or more general purpose processors such as CPUs or micro processing unit (MPUs), or one or more dedicated processors specialized for a particular process. Alternatively, the controller 33 may include dedicated circuitry, such as one or more FPGAs or ASICs. The controller 33 operates according to a control and processing program, or operates according to an operation procedure implemented as circuitry, to comprehensively control the operation of the consumer terminal apparatus 11. The controller 33 then transmits and receives various types of information to and from the server apparatus 10 and the like via the communication interface 31 and executes the operations according to the present embodiment.

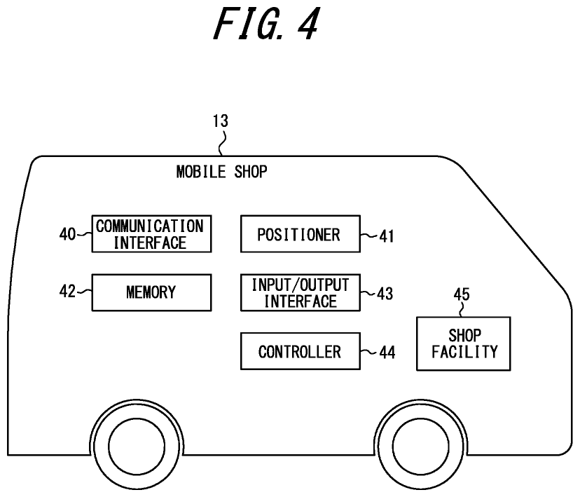

FIG. 4 illustrates an example configuration of the mobile shop 13. The mobile shop 13 is a multi-purpose vehicle in which equipment corresponding to a particular application can be loaded to the vehicle interior space. In the present embodiment, the mobile shop 13 is configured to have a shop facility 45 mounted therein for selling food products. The shop facility 45 includes a kitchen facility provided with cooking utensils, seasoning, containers for assortments, and the like to enable ingredients to be cooked or arranged in containers to reconfigure a food product. This shop facility 45 may be managed and operated by a salesperson onboard the mobile shop 13 or may be operated by an automatic machine controlled by a computer. The mobile shop 13 uses the shop facility 45 to reconfigure food products collected from the retail shop 17, 18. The mobile shop 13 then parks at arbitrary parking locations while patrolling along a predetermined patrol route or parks at an arbitrary location in response to consumer demand and sells food products reconfigured by the shop facility 45 to consumers. The shop facility 45 is configured to be open to the outside of the vehicle so that consumers outside the vehicle can view and handle the food products in the shop facility 45. Alternatively, the shop facility 45 may be configured so that consumers can enter the interior to view and handle food products.

The mobile shop 13 further includes a communication interface 40, a positioner 41, a memory 42, an input/output interface 43, and a controller 44. The components are communicably connected to each other in a wired or wireless manner via an on-board network, such as a controller area network (CAN), or a dedicated line, for example. Some or all of the communication interface 40, positioner 41, memory 42, input/output interface 43, and controller 44 may be provided directly in the mobile shop 13 or may be provided in a control apparatus that is detachable from the mobile shop 13, such as a car navigation apparatus. The mobile shop 13 may be driven by a driver, or driving may be automated at any level. The level of automation is, for example, one of level 1 to level 5 in the level classification of the Society of Automotive Engineers (SAE).

The communication interface 40 includes a communication module compliant with a wired or wireless LAN standard, a module compliant with a mobile object communication standard such as 4G or 5G, or the like. The mobile shop 13 is connected to the network 12 by the communication interface 40 via a base station for mobile object communication and communicates information with other devices over the network 12.

The positioner 41 measures the position of the mobile shop 13 and generates position information. The position information is information including coordinates, such as two-dimensional coordinates or three-dimensional coordinates, that identify a position on a map. The position information is not limited to coordinates and may include the speed, patrol route, or travel distance, the amount or rate of change thereof, or the like. The positioner 41 includes a receiver corresponding to a satellite positioning system. The satellite positioning system to which the receiver corresponds may, for example, be a global positioning system (GPS). Alternatively, the positioner 41 may include an accelerometer, a gyroscopic sensor, or the like. A car navigation apparatus, for example, may function as the positioner 41.

The memory 42 includes, for example, a semiconductor memory, a magnetic memory, or an optical memory. The memory 42 functions as, for example, a main storage device, an auxiliary storage device, or a cache memory. The memory 42 stores any information, control and processing programs, and the like used for controlling the operation of the mobile shop 13.

The input/output interface 43 includes an input interface that detects user input and transmits the input information to the controller 44. The input interface may be any type of input interface, such as a physical key, a capacitance key, a touch screen integrally provided with a panel display, various pointing devices, a microphone for receiving audio input, a camera for capturing images or image codes, an IC card reader, or the like. The input/output interface 43 also includes an output interface that outputs information, generated by the controller 44 or received from the server apparatus 10, to the user. The output interface may be any type of output interface, such as a display for outputting information as an image or video, a speaker for outputting information as audio, or an interface for connecting with an external output device.

The controller 44 may include one or more general purpose processors, such as CPUs or MPUs, or one or more dedicated processors specialized for a particular process. Alternatively, the controller 44 may include dedicated circuitry, such as one or more FPGAs or ASICs. The controller 44 operates according to a control and processing program, or operates according to an operation procedure implemented as circuitry, to comprehensively control the operation of the mobile shop 13, including the communication interface 40, positioner 41, memory 42, input/output interface 43, and shop facility 45. When the mobile shop 13 is driven automatically, the controller 44 transmits the information required for the operation of the mobile shop 13, such as position information acquired by the positioner 41 and map information read from the memory 42, to a control apparatus that controls automatic driving. The controller 44 transmits and receives various information to and from the server apparatus 10 via the communication interface 40 and executes the operations according to the present embodiment.

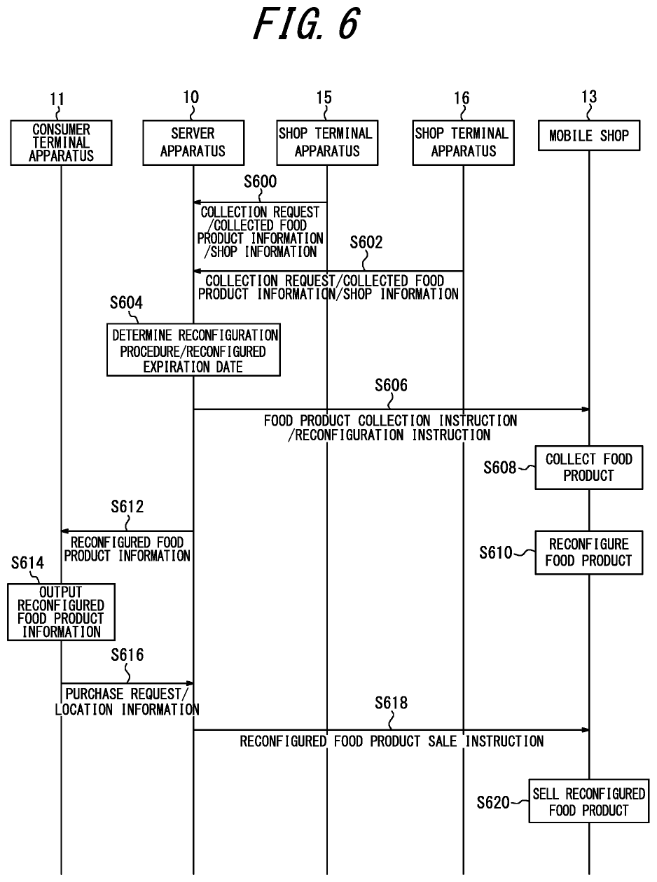

FIG. 6 is a sequence diagram illustrating an operation example of the information processing system 1. FIG. 6 illustrates operation procedures for cooperative operation by the server apparatus 10, the consumer terminal apparatus 11, the shop terminal apparatuses 15, 16, and the mobile shop 13. The procedures of FIG. 6 are executed when a request for collection of a food product near its expiration date is generated in the retail shops 17, 18, for example.

In accordance with input from the clerk of the retail shop 17, the controller 33 of the shop terminal apparatus 15 transmits a request to collect a food product from the retail shop 17, collected food product information indicating the food product to be collected, and shop information specifying the shop to the server apparatus 10 via the communication interface 31 in step S600. The collected food product information includes the ingredient types of the food product to be collected, the food product expiration date, the ingredients included in the food product, and the expiration date of each ingredient. The shop information is information specifying the retail shop 17 and includes the shop name, position information indicating the location, and the like. For example, the controller 33 reads the food product information 54 from the memory 32 and displays the information with the input/output interface 30. The clerk then selects the food product to be collected. The clerk may use the input/output interface 30 to freely input the food product to be collected, the ingredients included in the food product, and the expiration date of each ingredient. The controller 33 may, for example, read shop information stored in the memory 32 in advance, or the clerk may input the shop information using the input/output interface 30. The controller 33 generates a collection request and transmits the collection request, collected food product information, and shop information to the server apparatus 10. The controller 22 of the server apparatus 10 then receives the request to collect a food product, the collected food product information, and the shop information via the communication interface 20. Shop information including position information of the retail shop 17 may be stored in advance in association with a shop ID as member shop information in the memory 21 of the server apparatus 10. When a clerk transmits a shop ID from the shop terminal apparatus 15, the controller 22 of the server apparatus 10 may then read the shop information of the retail shop 17 corresponding to the shop ID.

In step S602, as in step S600, the controller 33 of the shop terminal apparatus 16 transmits a request to collect a food product from the retail shop 18, the collected food product information, and the shop information to the server apparatus 10 via the communication interface 31 in response to operation by the clerk of the retail shop 18. The controller 22 of the server apparatus 10 then receives the request to collect a food product, the collected food product information, and the shop information via the communication interface 20.

In step S604, the controller 22 of the server apparatus 10 determines a reconfiguration procedure for reconfiguring the food products collected from the retail shops 17, 18 and the expiration date of the reconfigured food product (reconfigured expiration date). For example, the controller 22 identifies the ingredient type of the nearly expired ingredient with the nearest ingredient expiration date for each piece of collected food product information received from the shop terminal apparatuses 15, 16. Alternatively, the controller 22 may identify two or more ingredients, having expiration dates within a freely set period of time, as nearly expired ingredients. The controller 22 then searches the reconfiguration procedure information 52 for a reconfiguration pattern to cook, remove, or replace one or more nearly expired ingredients. When the controller 22 finds a reconfiguration pattern to replace a nearly expired ingredient, the controller 22 also selects a replacement ingredient type having an ingredient expiration date later than the ingredient expiration date of the nearly expired ingredient. The controller 22 selects the replacement ingredient type from among other collected food product information or reconfigured food products yielded by reconfiguration. When a plurality of replacement ingredient types are found, the controller 22 selects the ingredient type with the latest ingredient expiration date as the replacement ingredient. The controller 22 then combines the reconfiguration pattern with information identifying the replacement ingredient to generate the reconfiguration procedure.

Furthermore, the controller 22 determines the reconfigured expiration date of the reconfigured food product. For example, the controller 22 determines that the latest ingredient expiration date among the ingredient expiration dates of the ingredient types in the reconfigured food product is the reconfigured expiration date. When an uncooked ingredient is cooked, the controller 22 delays the ingredient expiration date of the uncooked ingredient by a freely-set ratio and uses the ingredient expiration date of the ingredient to determine the reconfigured expiration date.

In step S606, the controller 22 of the server apparatus 10 transmits a food product collection instruction and a reconfiguration instruction to the mobile shop 13 via the communication interface 20. The shop information and collected food product information of the retail shops 17, 18 are included in the food product collection instruction. The reconfiguration procedure and the reconfigured expiration date for each food product to be collected are included in the reconfiguration instruction. The controller 44 of the mobile shop 13 then receives the food product collection instruction and the reconfiguration instruction via the communication interface 40.

In step S608, the controller 44 of the mobile shop 13 controls the mobile shop 13 to collect the food products from the retail shops 17, 18. For example, the controller 44 outputs the positions of the retail shops 17, 18 using the display of the input/output interface 43 and instructs the crew member of the mobile shop 13 to patrol to the retail shops 17, 18 and collect the food products. The controller 44 may also transmit an instruction to patrol to the retail shops 17, 18 to an automatic driving control apparatus of the mobile shop 13 to cause the mobile shop 13 to patrol to the retail shops 17, 18. At the retail shops 17, 18, a clerk and/or the crew member of the mobile shop 13 loads the food products to be collected into the shop facility 45 of the mobile shop 13 manually or with an automatic machine.

In step S610, the collected food products are reconfigured in the shop facility 45 of the mobile shop 13. The controller 44 of the mobile shop 13 may, for example, display the reconfiguration procedure for each food product to the crew member of the shop facility 45 using the display of the input/output interface 43 to prompt reconfiguration of the collected food products. When an automatic cooking machine is mounted in the shop facility, the controller 44 transmits information necessary for reconfiguration to a control apparatus of the automatic machine to cause the automatic machine to reconfigure the food products. The food products are reconfigured by the nearly expired ingredient in each food product being cooked, removed, or replaced by an ingredient with a later ingredient expiration date in accordance with the reconfiguration procedure, for example. The reconfigured expiration date is attached to the reconfigured food product by the crew member or an automatic machine in the shop facility 45. For example, a label or the like indicating the reconfigured expiration date may be added to the reconfigured food product.

In step S612, the controller 22 of the server apparatus 10 transmits the reconfigured food product information indicating the reconfigured food product to the consumer terminal apparatus 11 via the communication interface 20. The reconfigured food product information includes information on the type of reconfigured food product, the ingredient types included in the reconfigured food product, the reconfigured expiration date, and the like corresponding to the reconfiguration instruction that the server apparatus 10 sent to the mobile shop 13. The controller 33 of the consumer terminal apparatus 11 receives the reconfigured food product information via the communication interface 31.

In step S614, the controller 33 of the consumer terminal apparatus 11 outputs the reconfigured food product information via the input/output interface 30. For example, the controller 33 displays the type of reconfigured food product, the included ingredient types, the reconfigured expiration date, and the like on the display. When the consumer inputs a request to purchase the reconfigured food product and the consumer's location to a touch panel integrated with the display, the controller 33 receives information indicating the purchase request and information on the location.

In step S616, the controller 33 of the consumer terminal apparatus 11 transmits information indicating the request to purchase the reconfigured food product and location information to the server apparatus 10 via the communication interface 31. The controller 22 of the server apparatus 10 then receives the information indicating the request to purchase the reconfigured food product and the location information of the consumer via the communication interface 20.

In step S618, the controller 22 of the server apparatus 10 transmits a sale instruction for the reconfigured food product to the mobile shop 13 via the communication interface 20. Information on the location of the consumer together with an instruction to stop by the location are included in the sale instruction. The controller 44 of the mobile shop 13 receives the sale instruction for the reconfigured food product via the communication interface 40.

In step S620, the controller 44 of the mobile shop 13 controls the mobile shop 13 to sell the reconfigured food product. For example, the controller 44 outputs the location of the consumer using the display of the input/output interface 43 and causes the crew member of the mobile shop 13 to move to the location of the consumer and sell the reconfigured food product. The controller 44 may also cause the mobile shop 13 to move to the location of the consumer by transmitting an instruction the move to the location of the consumer to an automatic driving control apparatus of the mobile shop 13. This enables the consumer to purchase the reconfigured food product from the mobile shop 13.

With the aforementioned procedure, food products near their expiration date are collected from the retail shops 17, 18, reconfigured, and sold as reconfigured food products with extended expiration dates. This can increase the sales efficiency of food products near their expiration date in the retail shops 17, 18.

As a modification to the procedure of FIG. 6, the consumer may operate the consumer terminal apparatus 11 before step S604, for example, to transmit the reconfiguration procedure desired by the consumer from the consumer terminal apparatus 11 to the server apparatus 10, and the server apparatus 10 may add the reconfiguration procedure received from the consumer terminal apparatus 11 to the reconfiguration patterns of the reconfiguration procedure information 52. The probability of the consumer acquiring a desired reconfigured food product thereby increases, increasing convenience for the consumer. Alternatively, the consumer terminal apparatus 11 that transmits the reconfiguration procedure to the server apparatus 10 and the consumer terminal apparatus 11 that transmits a purchase request to the server apparatus 10 may be different terminal apparatuses. In this case, one consumer has an opportunity to purchase a reconfigured food product reconfigured by the reconfiguration procedure desired by another consumer, enabling the consumer to enjoy an element of unpredictability.

In steps S600 and S602, the shop terminal apparatuses 15, 16 may each transmit a collection request including the time for the mobile shop 13 to collect the food product, and in step S606, the server apparatus 10 may transmit a food product collection instruction that designates the time to the mobile shop 13. For example, the collection of food products expected not to sell out during business hours can be requested with the designation of a time after the retail shops 17, 18 close, so that the mobile shop 13 collects the food products after the retail shops 17, 18 close. Furthermore, in step S616, the consumer terminal apparatus 11 may transmit, to the server apparatus 10, a purchase request designating the time for the mobile shop 13 to patrol, and in step S618, the server apparatus 10 may transmit, to the mobile shop 13, a reconfigured food product sale instruction designating the time to patrol to the location of the consumer. The mobile shop 13 then responds to the instruction by patrolling to the location of the consumer at the designated time in step S620. For example, if a consumer misses the chance to shop during business hours of the retail shops 17, 18 but still wishes to shop after the retail shops 17, 18 close, the consumer can gain an opportunity to shop. This increases convenience for the consumer.

Steps S612 to S616 may be omitted, the server apparatus 10 may transmit an instruction to the mobile shop 13 in step S618 to sell the reconfigured food products at random while patrol selling, and the mobile shop 13 may sell the reconfigured food products while patrol selling along a predetermined patrol route in step S620.

An example of food products near their expiration date being collected from the retail shops 17, 18 has been described in the above embodiment, but expired food products may be collected. Even if the expiration date of a food product is reached, ingredients before their expiration date may be included in the food product and be used to create a reconfigured food product. Hence, the food products for which the shop terminal apparatuses 15, 16 transmit the collection request to the server apparatus 10 during operations of the information processing system 1 may be expired food products. The case of collecting a food product from a single retail shop and creating a reconfigured food product is also included in the present embodiment.

In the above embodiment, a processing/control program that specifies operations of the controller 33 of the consumer terminal apparatus 11 and the shop terminal apparatuses 15, 16 may be stored in the memory 21 of the server apparatus 10 or in the memory of another server apparatus and be downloaded onto each terminal apparatus via the network 12. The processing/control program may also be stored on a non-transitory recording/storage medium readable by each terminal apparatus, and each terminal apparatus may read the program from the medium. A processing/control program that specifies operations of the controller 44 of the mobile shop 13 may be stored in the memory 21 of the server apparatus 10 or in the memory of another server apparatus and be downloaded onto the mobile shop 13 via the network 12. The processing/control program may also be stored on a non-transitory recording/storage medium readable by the controller 44, and the controller 44 may read the program from the medium.

Although embodiments have been described on the basis of drawings and examples, it is to be noted that various changes and modifications may be implemented by those skilled in the art based on the present disclosure. Therefore, such changes and modifications are to be understood as included within the scope of the present disclosure. For example, the functions and the like included in the various means and steps may be reordered in any logically consistent way. Furthermore, means and steps may be combined into one or divided.

1. A server apparatus comprising:
a communication interface; and
a controller configured to transmit and receive information to and from other apparatuses via the communication interface,
wherein the controller is configured to:
receive, from a shop terminal apparatus of a shop, information on a food product to be collected;
transmit, to a mobile shop configured to collect the food product, a reconfiguration procedure for reconfiguring an ingredient included in the food product to yield a reconfigured food product having an expiration date later than an expiration date of the food product; and
prompt the mobile shop to sell the reconfigured food product.

2. The server apparatus of claim 1, wherein the reconfiguration procedure includes a procedure to cook an ingredient included in the food product to be collected, to remove the ingredient, or to replace the ingredient with an ingredient included in another food product.

3. The server apparatus of claim 1, wherein the controller is configured to:
receive, from a consumer terminal apparatus, a request for the mobile shop to patrol to a predetermined location; and
instruct the mobile shop to patrol to the predetermined location.

4. The server apparatus of claim 3, wherein:
a request, designating a predetermined time slot, for the mobile shop to patrol to the predetermined location is transmitted from the consumer terminal apparatus; and
the controller is configured to instruct the mobile shop to patrol to the predetermined location at the predetermined time slot.

5. The server apparatus of claim 4, wherein the predetermined time slot is a time slot after the shop closes.

6. The server apparatus of claim 3, wherein the reconfiguration procedure is received from the consumer terminal apparatus.

7. The server apparatus of claim 3, wherein the reconfiguration procedure is received from another consumer terminal apparatus.

8. The server apparatus of claim 1, wherein the reconfigured food product is reconfigured based on ingredients included in food products collected from a plurality of shops.

9. An information processing system comprising the server apparatus of claim 1 and the mobile shop.

10. A control apparatus to be mounted in a mobile shop and configured to transmit and receive information to and from a server apparatus and to control the mobile shop, wherein:
the control apparatus is configured to receive a reconfiguration procedure from a server apparatus configured to receive, from a shop terminal apparatus of a shop, information on a food product to be collected, the reconfiguration procedure being a procedure for a mobile shop configured to collect the food product, to reconfigure an ingredient included in the food product and yield a reconfigured food product having an expiration date later than an expiration date of the food product; and
the control apparatus is configured to output an instruction to collect the food product from the shop, reconfigure the food product, and sell the reconfigured food product.

11. A non-transitory computer readable medium storing a program which, when executed by a computer, causes the computer to operate as the control apparatus of claim 10.

12. A mobile shop comprising the control apparatus of claim 10 and a facility for reconfiguring the food product.

13. A non-transitory computer readable medium storing a program which, when executed by a computer capable of input and output of information, causes the computer to operate as the shop terminal apparatus and communicate with the server apparatus of claim 1.

14. A non-transitory computer readable medium storing a program which, when executed by a computer capable of input and output of information, causes the computer to operate as the consumer terminal apparatus and communicate with the server apparatus of claim 3.

15. An operation method for an information processing system comprising a server apparatus and a mobile shop configured to communicate with the server apparatus, the operation method comprising:
receiving, at the server apparatus from a shop terminal apparatus of a shop, information on a food product to be collected;
transmitting, from the server apparatus to the mobile shop, a reconfiguration procedure for reconfiguring an ingredient included in the food product to yield a reconfigured food product having an expiration date later than an expiration date of the food product; and
prompting, by the server apparatus, the mobile shop to sell the reconfigured food product.

16. The operation method of claim 15, wherein the reconfiguration procedure includes a procedure to cook an ingredient included in the food product to be collected, to remove the ingredient, or to replace the ingredient with an ingredient included in another food product.

17. The operation method of claim 15, further comprising:
receiving, at the server apparatus from a consumer terminal apparatus, a request for the mobile shop to patrol to a predetermined location; and
instructing, by the server apparatus, the mobile shop to patrol to the predetermined location.

18. The operation method of claim 17, further comprising:
receiving, at the server apparatus from the consumer terminal apparatus, a request for the mobile shop to patrol to the predetermined location, the request designating a predetermined time slot; and
instructing, by the server apparatus, the mobile shop to patrol to the predetermined location at the predetermined time slot.

19. The operation method of claim 15, wherein the reconfigured food product is reconfigured based on ingredients included in food products collected from a plurality of shops.

20. The operation method of claim 15, further comprising:
outputting, by the mobile shop, an instruction to collect food products from a plurality of the shops, reconfigure the food products, and sell the reconfigured food products.
